(19) United States
(12) Patent Application Publication
(10) Pub. No.: US 2007/0297590 A1
(43) Pub. Date: Dec. 27, 2007

(54) MANAGING ACTIVITY-CENTRIC ENVIRONMENTS VIA PROFILES

(75) Inventors: Steven W. Macbeth, Snohomish, WA (US); Roland L. Fernandez, Woodinville, WA (US); Brian R. Meyers, Issaquah, WA (US); Desney S. Tan, Kirkland, WA (US); George G. Robertson, Seattle, WA (US); Nuria M. Oliver, Seattle, WA (US); Oscar E. Murillo, Seattle, WA (US); Mary P. Czerwinski, Woodinville, WA (US); Jeanine E. Spence, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/426,810

(22) Filed: Jun. 27, 2006

(51) Int. Cl. H04M 3/42

(52) U.S. Cl. 379/201.02

(57) ABSTRACT

A unique system and method is provided that facilitates managing an activity centric environment via a master profile (which includes user, group, and device profiles). The master profile follows or stays with the user and can be applied universally across devices and activities (activity templates). When profile data does not currently exist (e.g., a new activity or a new device), portions of the existing profile data can be applied to such new activities or device as appropriate. Thus, current profile data for existing or known user interactions and devices can be inferentially extended to new user interactions and devices. When conflicts arise between applicable profile data, they can be solved by applying the profile data in accordance with their priority. User intervention can be requested whereby the system can adapt previous user-based resolutions to future conflicts. Profile data can also be scaled according to the context of the user-device-activity interaction.

### CROSS REFERENCE TO RELATED APPLICATIONS

This application is related to U.S. patent application Ser. No. ______ (Attorney Docket Number MS315859.01/MSFTP1290US) filed on Jun. 27, 2006, entitled “LOGGING USER ACTIONS WITHIN ACTIVITY CONTEXT”; Ser. No. ______ (Attorney Docket Number MS315860.01/MSFTP1291US) filed on Jun. 27, 2006, entitled “RESOURCE AVAILABILITY FOR USER ACTIVITIES ACROSS DEVICES”; Ser. No. ______ (Attorney Docket Number MS315861.01/MSFTP1292US) filed on Jun. 27, 2006, entitled “CAPTURE OF PROCESS KNOWLEDGE FOR USER ACTIVITIES”; Ser. No. ______ (Attorney Docket Number MS315862.01/MSFTP1293US) filed on Jun. 27, 2006, entitled “PROVIDING USER INFORMATION TO INTROSPECTION”; Ser. No. ______ (Attorney Docket Number MS315863.01/MSFTP1294US) filed on Jun. 27, 2006, entitled “MONITORING GROUP ACTIVITIES”; Ser. No. ______ (Attorney Docket Number MS315865.01/MSFTP1296US) filed on Jun. 27, 2006, entitled “CREATING AND MANAGING ACTIVITY-CENTRIC WORKFLOW”; Ser. No. ______ (Attorney Docket Number MS315866.01/MSFTP1297US) filed on Jun. 27, 2006, entitled “ACTIVITY-CENTRIC ADAPTIVE USER INTERFACE”; Ser. No. ______ (Attorney Docket Number MS315867.01/MSFTP1298US) filed on Jun. 27, 2006, entitled “ACTIVITY-CENTRIC DOMAIN SCOPING”; and Ser. No. ______ (Attorney Docket Number MS315868.01/MSFTP1299US) filed on Jun. 27, 2006, entitled “ACTIVITY-CENTRIC GRANULAR APPLICATION FUNCTIONALITY”. The entirety of each of the above applications is incorporated herein by reference.

### BACKGROUND

Traditionally, communications between humans and machines have been relatively inefficient. Human-to-human communication typically involves spoken language combined with hand and facial gestures or expressions, with the humans understanding the context of the communication. Human-machine communication is typically much more constrained, with devices like keyboards and mice for input, and symbolic or iconic images on a display for output, and with the machine understanding very little of the context. For example, although communication mechanisms (e.g., speech recognition systems) continue to develop, these systems do not automatically adapt to the activity of a user. As well, traditional systems do not consider contextual factors (e.g., user state, application state, environment conditions) to improve communications and interactivity between humans and machines.

Activity-centric concepts are generally directed to ways to make interaction with computers more seamless and efficient (by providing some additional context for the communication). Traditionally, computer interaction centers around one of three pivots: 1) document-centric, 2) application-centric, and 3) device-centric. However, most conventional systems cannot operate upon more than one pivot simultaneously, and those that can do not provide much assistance managing the pivots. Hence, users are burdened with the tedious task of managing every little aspect of their tasks/activities.

A document-centric system refers to a system where a user first locates and opens a desired data file before being able to work with it. Similarly, conventional application-centric systems refer to first locating a desired application, then opening and/or creating a file or document using the desired application. Finally, a device-centric system refers to first choosing a device for a specific activity and then finding the desired application and/or document and subsequently working with the application and/or document with the chosen device.

Accordingly, since the traditional computer currently has little or no notion of activity built in to it, users are provided little direct support for translating the “real world” activity they are trying to use the computer to accomplish and the steps, resources and applications necessary on the computer to accomplish the “real world” activity. Thus, users traditionally have to assemble “activities” manually using the existing pieces (e.g., across documents, applications, and devices). As well, once users manually assemble these pieces into activities, they need to manage this list mentally, as there is little or no support for managing this on current systems.

Moreover, the activity-centric concept is based upon the notion that users are leveraging a computer to complete some real world activity. Historically, a user has had to mentally outline and prioritize the steps or actions necessary to complete a particular activity before starting to work on that activity on the computer. Conventional systems do not provide for systems that enable the identification and decomposition of actions necessary to complete an activity. In other words, there is currently no integrated mechanism available that can dynamically understand what activity is taking place as well as what steps or actions are necessary to complete the activity.

In addition, the conventional computer system has used the desktop metaphor, where there is only one desktop. These systems store documents in essentially a single filing cabinet. As the complexity of activities rises and as the similarity of the activities diverges, this structure does not offer user-friendly access to necessary resources for a particular activity.

### SUMMARY

The following presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

The subject application provides at least one system and method that facilitate the creation, prioritization, management, and sharing of user, group, and device profile data across various applications and devices that exist or are operating in an activity-centric environment. More specifically, multi-faceted user profiles can be generated and made available to any device or application in-use or activated in the activity-centric environment to facilitate the performance or coordination of activities of one or more users. As a result, user-based profile information can be more readily accessed and maintained to improve overall consistency of the information particularly when multiple devices, applications, and/or users are involved in an activity.

Profiles can be generated implicitly and/or explicitly and can include fixed policies and/or flexible user-selected preference settings. An activity monitoring module can recognize a user's (or group's) current activity or task and make suggestions or implementations according to the controlling profile (e.g., user, group, device, etc.) to further improve the performance of the activity. When appropriate, the controlling profile can be chosen depending on whether a group-based or individual user activity is being performed. Thus, available profiles can be applied in a hierarchical manner depending on the user or group, the activity, the application, and/or the device. Conflicts between profiles or profile settings can be resolved according to the context of the conflict. For example, in one situation, an application setting may take precedence over a group or user setting; however, in another context, a device setting may take precedence over user and activity settings. In addition, the system can resolve conflicts or suggest possible resolutions to conflicts in part by using machine learning to determine the most reasonable options based on at least one of the following: user profile for one or more users, group profile information, activity, relevant device(s), and relevant application(s).

A user profile can include user-selected settings to personalize the user's computing environment, settings for the user's devices, network access, and security privileges, and settings for the user's applications (e.g., word processing, drawing, spreadsheet, media, and messaging applications). A group profile can include settings that are for the group and thus common and applicable to each and/or all of the members of such group as well as any applications and devices employed by the group.

Device profiles may also be created using similar techniques. In particular, they can be either implicitly or explicitly created. A device profile contains activity-specific information about the device. For example, it can include information about whether the device has been used successfully (or unsuccessfully) for the activity or for particular steps of the activity. As with user and group profiles, device profiles can also be selectively exposed to the system or to other users, groups, or devices. For example, a personal mobile device (e.g., a PDA, pocket PC phone, smartphone, or the like) can have a device profile that is only accessible to the user who owns the device.

Both user and group profiles can be created using similar techniques. In particular, they can be implicitly and/or explicitly generated. For example, the activity monitoring module can collect data about a user's interactions in the computing environment (e.g. network). The system can analyze the data and draw conclusions, make inferences, and learn from the user's actions or “behavior”. From this, one or more portions of the user profile can be created, updated, and/or modified. The user can also manually enter setting information. Similarly, the activity monitoring module can collect data from group-related interactions with the network with respect to one or more (or all) members of a designated group. The monitoring module can also evaluate any profile data already established for any individuals in the group and determine the weight of each individual profile data and whether to incorporate any such data in the group profile. If at least one specific activity is indicated by or for the group (e.g. patenting) or identified as the group's purpose, then the collected data including data evaluated from the member's individual profiles can be analyzed with respect to the indicated activity(s). By doing so, the system can make more accurate setting selections to optimize the performance of the activity and improve the group's overall efficiency with respect to current and future activities.

Due to privacy concerns, profile data can be selectively exposed to the system or to other users or groups. In particular, a user can mark or otherwise identify portions of content within the profile as private or allow selective access to the content to authorized systems, devices, users, or groups. Permission to view any restricted content can be requested and granted in an on-demand manner as well. In addition, the profile data can be scaled or made dependent upon other factors such as environmental factors. For example, a music setting can be selected or activated based on the current room lighting or the state of the user's device (e.g., safe mode, sleep mode, screensaver on, etc.).

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a profile management system that facilitates managing user activity in an activity-centric computing environment via the creation of a master profile.

FIG. 2 is a block diagram of a profile management system that makes selective use of one or more profiles in order to facilitate an activity-centric computing environment.

FIG. 3 is a block diagram of another aspect of an activity management system that facilitates protecting or restricting access to at least a portion of profile data.

FIG. 4 is an exemplary diagram that demonstrates the collection of data in order to generate or augment one or more profiles (e.g., user, group, or device).

FIG. 5 is an exemplary diagram that demonstrates the employment of profile data by an activity template based on the identification of the activity.

FIG. 6 is a block diagram of another aspect of an activity management system that facilitates scaling of profile data according to a current context.

FIG. 7 is a flow diagram of an exemplary method that facilitates managing user activity in an activity-centric computing environment via the creation of a master profile.

FIG. 8 is a flow diagram of an exemplary method that makes selective use of one or more profiles in order to facilitate an activity-centric computing environment.

FIG. 9 is a flow diagram of an exemplary method that facilitates scaling of profile data according to a current context.

FIG. 10 is a block diagram of an overall activity-centric system that is operable to perform the monitoring and activity-based functionalities described herein.

### DETAILED DESCRIPTION

The subject systems and/or methods are now described with reference to the drawings, wherein like reference numerals are used to refer to like elements throughout. In the following description, for purposes of explanation, numerous specific details are set forth in order to provide a thorough understanding of the systems and/or methods. It may be evident, however, that the subject systems and/or methods may be practiced without these specific details. In other instances, well-known structures and devices are shown in block diagram form in order to facilitate describing them.

As used herein, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

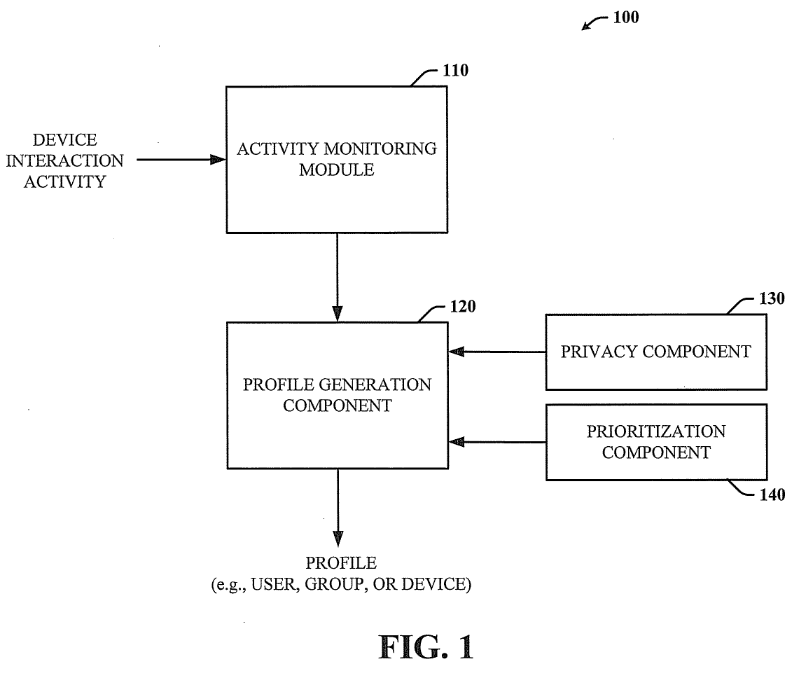

Referring now to FIG. 1, there is a block diagram of a profile management system 100 that facilitates managing user activity in an activity-centric computing environment via the creation of a master or universal profile (the user, group, and device profiles associated with a user). The system 100 includes an activity monitoring module 110 that can monitor activity conducted on one or more computing devices and collect data associated with such activity. For example, the monitoring module 110 can collect data about the user as he interacts with his one or more devices. The data collected can be communicated to a profile generation component 120 that can use the raw data to directly create a new or modify an existing profile. Additionally, the raw data can be processed or analyzed and used to infer other preferences or profile settings for the user. In practice for instance, imagine that the user systematically accesses a media player to listen to music and watch video but does not explicitly specify such program in his profile. Through the activity monitoring module 110, the raw data shows that the user typically selects the particular media player to listen to music and watch video. Thus, the profile generation component 120 can infer that the media player is the most likely program that the user will use for listening to music and watching video. As a result, the next time he opens a music or video file, the preferred media player can automatically open.

Likewise, certain listening preferences can be learned as well. For example, suppose the user consistently sets the volume no higher than 5 when listening to classical genre music but at least 6 when listening to rock genre music. The profile generation component 120 can distinguish between the genres of music and the listening preferences of the user in order to adjust the volume setting automatically for this type of activity as well as for related types of activities where no preferences have been indicated (e.g. watching video or other streaming content).

Program/application specific preferences can be inferred as well. For example, imagine that historic data collected over time reflects that the user opens his messages from newest to oldest. The profile generation component 120 can analyze this data and infer that they represent user preferences and can add them to the user's profile for this particular program. These preferences can also be extended and applied to other similar activities such as viewing files—files can be automatically re-arranged newest to oldest (in terms of creation or modification date). Thus, the user is not burdened with setting preferences for each and every activity.

Profiles created by the profile generation component 120 are device-independent which means that they can be universally accessed and employed by the user's various devices. More specifically, the user may have created a profile through activity conducted on his laptop, but at least a portion of the user profile data can be used by his PDA and pocket PC phone as well when conducting the same or similar activities. As a result, the user is not tasked with creating multiple profiles at separate times on each device.

Moreover, the different types of profile data (user, group, activity template, device, etc.) can be maintained together in a master profile. As discussed above, the master profile data for each user (or group) follows the respective user-owner and can be universally applied to new or existing activities, devices, and/or applications. This means that when the user obtains a new version of an application or an upgraded device, the existing profile data can be extended to such new objects where feasible as long as the user is involved in some way with the new application or device.

The profile generation component 120 can also construct group profiles. Group profiles are usually for the benefit and convenience of a group of users such as a department or design team, for example. Such users are typically associated by project, purpose, interest, or department and the settings reflect policies and/or preferences of the group rather than individual people in the group. Imagine that a general practice law firm includes departments of users whereby each department is designated to practice a different field of law (e.g., patent, commercial litigation, estate planning and probate, employee benefits, tax, etc.). Each field of law has different forms and filing procedures. In order to comply with such requirements, the profile generation component 120 can create a group profile for each department according to each department's policies and/or preferences. Examples of policies can include court filing rules relating to layout and format of documents (e.g., page limitations, party name nomenclature, case number, specific sections, and content); whereas examples of preferences can include template, font, font size, header/footer content, paper size, and signature line format.

Group profile data can be determined by a group leader who “speaks” for the group and represents its policies and preferences rather than any individual biases. The profile generation component 120 can also analyze the individual profiles belonging to each person in the group, extract any common preferences or policies, and include them in the group profile data. In addition, the profile generation component 120 can ascertain the purpose, intent, or focus of the group and suggest other policies or preferences accordingly. For example, if the group's purpose is recited as “U.S. Patent Law”, the profile generation component 120 can reference rules and regulations regarding patent related documents filed with the U.S. Patent Office and suggest certain policies or preferences to the group.

The profile generation component 120 can also generate device profiles from the data collected via the monitoring module 110. As previously mentioned, a device profile includes policies and preferences that are specific to the device. For instance, a handheld device can dictate the type of templates available to an activity (e.g., application or program) because of storage or screen-size limitations. Thus, if a user attempts to transfer a file from his laptop to his pocket PC phone, the device profile on the pocket PC phone can restrict or block this operation if the activity template does not comply with a policy.

In lieu of generating multiple device profiles for each of the user's devices, the master profile can include the relevant profile data for each device that the user owns. Thus, the device profile data can stay with the user rather than only with the device. When the user acquires a totally new device, a comparison can be made between the configurations of the new and existing devices. Existing profile data from an old device that is applicable in the new device can be applied to the new device to reduce the amount of time and effort required to build a new profile for the new device.

To mitigate privacy concerns, a privacy component 130 can control the sharing of profile data between devices as well as across applications, activity templates, groups, and users. In particular, the user-owner of such profile data can prevent certain profile data from being viewable by other entities unless the user-owner has authorized such access. For example, sensitive profile data for each device can be hidden from public view and accessed only by the authorized device. With the user's permission, the information can be made available and accessible to other devices. In practice, for instance, suppose that a user has a PDA and a laptop that are connected to the same network and the user wants to pass information from one device to the other. The pertinent device profile data can be shared between these two devices at the user's discretion to allow the passage of information. However, other device profile data not necessary for this exchange can be kept hidden.

Conflict between the types of profile data (e.g., user, group, device, etc.) for one user or between the profile data of collaborating users seems almost inevitable. To lessen the occurrence of conflicts, the profile generation component 120 can assign (by way of a prioritization component 140) priority levels to certain types of profile data or to certain policies or preferences included in the profile data. For example, a header/footer content policy set by a group can be given a higher priority than a similar user-made preference. Users or groups can also be prioritized such that any of their profile data can take precedence over that of another. For instance, a manager's profile data can always supersede an employee's profile data.

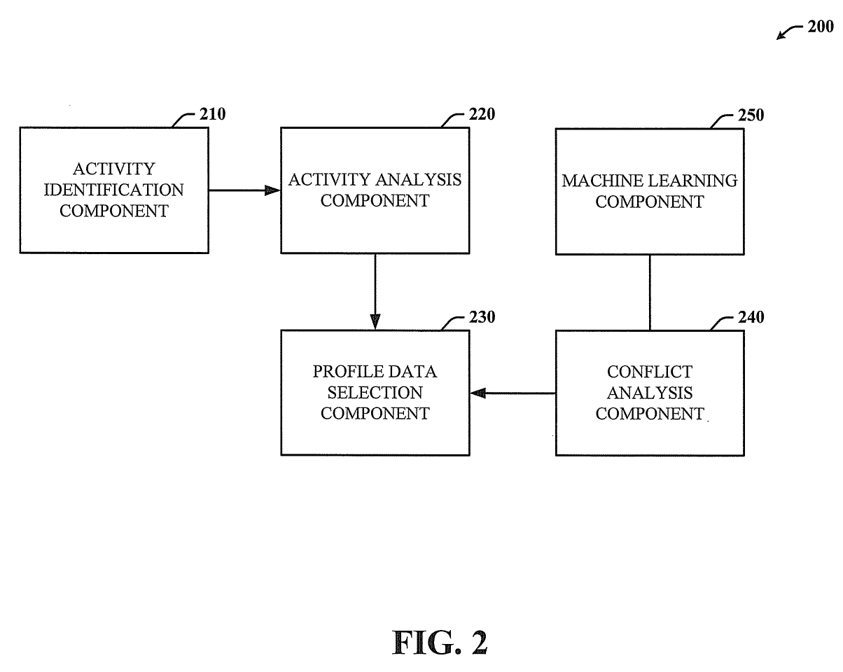

Turning now to FIG. 2, there is a block diagram of a profile management system 200 that makes selective use of profile data in order to facilitate an activity-centric computing environment. The system 200 includes an activity identification component 210 that identifies the kind or nature of the user, group, or device activity. Once identified, an activity analysis component 220 can determine whether the activity is user, group, and/or device oriented. Following therefrom, a profile data selection component 230 can select or access the appropriate or most relevant profile information.

As previously mentioned, conflict can arise between the different users' profiles when multiple users are involved in the same activity. For example, imagine that Josh, Chris, and Shane are collaborating on the design of a concept car. They may be working remotely from their individual devices or together on the same device (e.g., interactive tabletop computer). Each of their profiles indicates a different font preference: Josh—Bradley Hand; Chris—Verdana; and Shane—script. The system 200 can include a conflict analysis component 240 that analyzes the particular conflict and proposes various ways to resolve it. For example, the conflict analysis component 240 can look at the user's title, position, or level and follow the profile with the highest title, position, or level. Alternatively, the conflict analysis component 240 can look at the purpose or nature of the activity at hand to select one of the three choices or to choose a completely different font that is better suited for the group's purpose, focus, or intent.

Furthermore, these users are using an activity template for car design. The activity template can have its own profile data as well. Thus, the conflict analysis component 240 can determine whether the activity template profile overrides the user profiles. That is, the activity template could have a font policy which would have a higher priority than the user's font preference.

Generally speaking, most users typically have their own user profile and at least one device profile; and as a result, conflict can arise between these profiles as well. The user can prioritize their profiles or specific profile data so that the conflict analysis component 240 understands how to resolve such conflicts. In particular, the user can set one or more of his preferences to take precedence over a device preference. Some device settings cannot be displaced with user preferences though and the user can be notified when such is the case.

The conflict analysis component 240 can also rely on a machine learning component 250 when resolving profile conflicts. The machine learning component 250 can learn from how conflicts are resolved (either by the system or by the user) and then apply these principles when future conflicts arise. In the font example above, the machine learning component can learn that the Josh, Chris, and Shane resolved the conflict without system intervention—by choosing the most readable font of the three: Tahoma. When these users work again with each other and the same conflict arises, the conflict analysis component 240 can recall the previous resolution and apply it accordingly.

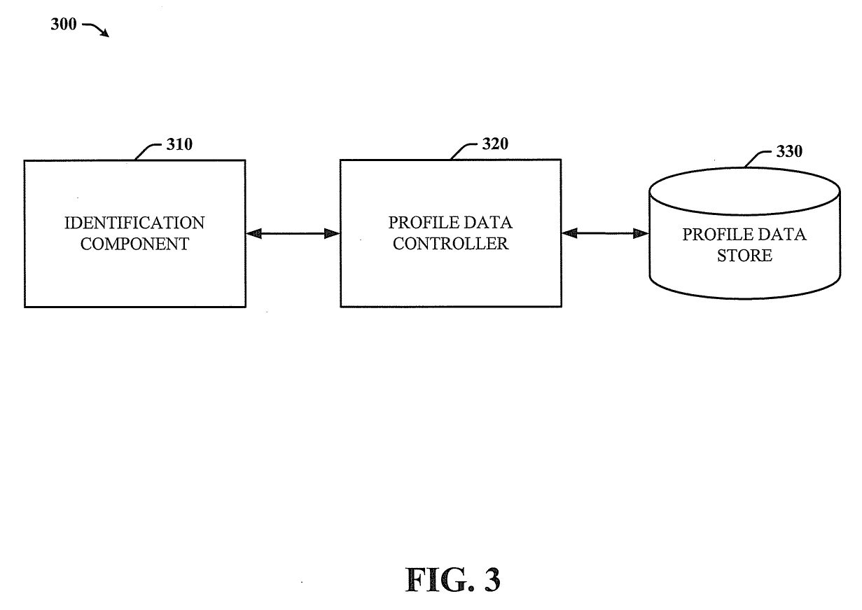

Turning now to FIG. 3, there is a block diagram of another aspect of an activity management system 300 that facilitates protecting or restricting access to at least a portion of profile data. Profiles generated in the manner described in FIG. 1 can include profile data for multiple devices, multiple activity templates, and multiple groups (of which the user is a member) and the user may not wish to share all or portions of his profile data between groups. The system 300 can control the exposure of profile data according to the relevant activity or device, for instance. In particular, an identification component 310 can identify the activity, user, or device that desires access to the profile data. After the identity is authenticated, a profile data controller 320 can selectively expose the appropriate profile data from a profile data store 330. The owner of the profile data can designate permissions to expand the amount of profile data that can be accessed or viewed by other users, groups, or devices. As a result, sensitive profile data can be protected.

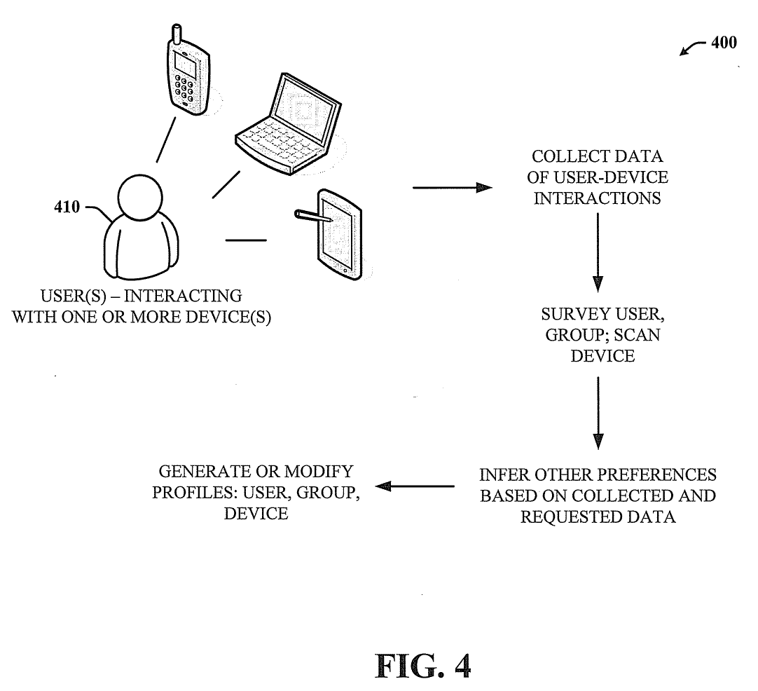

Referring now to FIG. 4, there is an exemplary diagram 400 that demonstrates the collection of data in order to generate or modify one or more profiles (e.g., user, group, or device). The diagram shows a user 410 interacting with at least one computing device (e.g., smartphone, laptop, PDA, and/or pocket PC). Information can be collected about the user, the user's interactions with the device(s), activity templates, and/or the device(s) as the user goes about his daily routine on the device(s). For example, suppose the user starts his day by reading his messages. Information about which application he uses to view his messages, the viewing order of his messages, the organization of his messages (e.g., manual filtering of messages), flagging or color coding of messages, and other operations performed while interacting with his messages can be collected and used to build his profile. The system or profile generator can also survey the user in order to discover additional information regarding his likes/dislikes. The user's laptop can be scanned as well to obtain its settings and/or requirements for optimal operation in order to build a device profile.

The collected data can be used in its raw form to populate various parts of the user or device profile; or the raw data or portions thereof can be analyzed to yield additional data that can be included in the profile(s). For instance, inference schemes can be employed to infer additional preferences or policies based on existing preferences, policies, and/or the raw data.

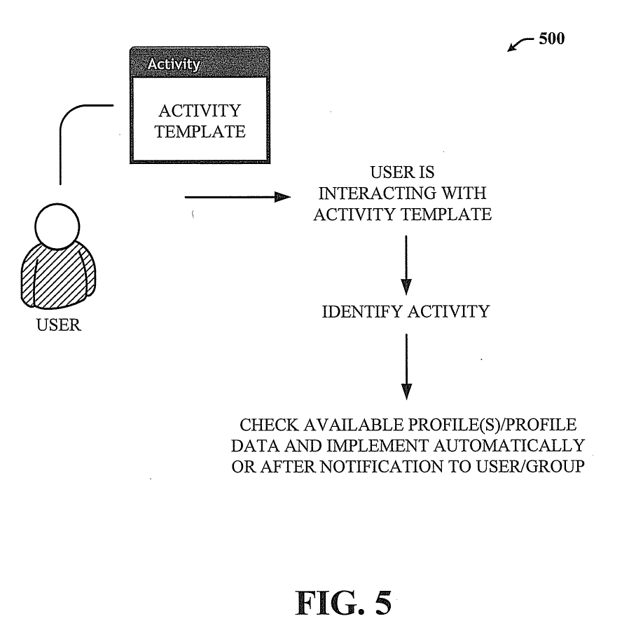

Moving on to FIG. 5, there is an exemplary diagram 500 that demonstrates the employment of profile data by an activity template based on the identification of the activity. As shown in the diagram, a user is interacting with an activity template such as a drawing template. The user's profile can include preference data and other settings for various activity templates and applications. To make accessing the relevant data more efficient, the device or system can initially identify the current activity (or activity template) and then access the pertinent data from the profile. Thus, system resources can be conserved and profile data can be automatically implemented where and when needed in a quick and efficient manner. On some occasions, the system can notify the user or group about a preference or policy that is about to be implemented to give the user or group an opportunity to accept or reject the implementation.

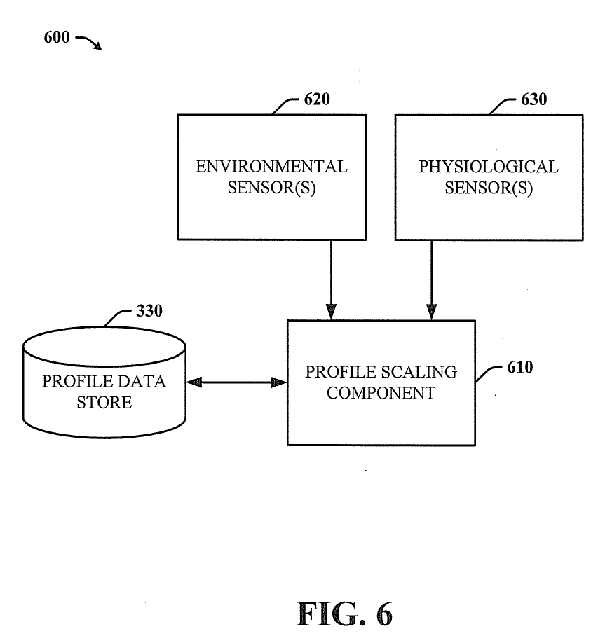

Turning to FIG. 6, there is a block diagram of another aspect of an activity management system 600 that facilitates scaling of profile data according to a particular context (e.g., subject activity, user condition, and/or environmental factor(s)). The system 600 includes a profile scaling component 610 that scales or adjusts the profile data applied to a user, device, group, or activity according to the present context. In particular, one or more environmental sensors 620 or one or more physiological sensors 630 can be employed to detect special conditions regarding the user, device, group, or activity. For example, suppose that a profile preference is dependent upon a physiological variable such as the user's heart rate. An exemplary profile could dictate that, when the user's heart rate is elevated (e.g., higher by W beats per minute than the usual baseline for that user), the user's preference may be to listen to Classical music (via a computing device) and to dim interior lights (controlled by the computing device). The musical preference selection can be set to change to Rock when the user's heart rate decreases to within a normal range. Thus, the applicable profile data can depend on the current context in addition to the user's activity. The profile data can be scaled according to existing conditions or the context of the activity. The priority of profile data or profiles can also be context-dependent. For example, a group preference can take precedence over a user preference except when specified contextual conditions exist (e.g., group performance review is poor and the user is now supervising the group).

Various methodologies will now be described via a series of acts. It is to be understood and appreciated that the subject system and/or methodology is not limited by the order of acts, as some acts may, in accordance with the subject application, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject application.

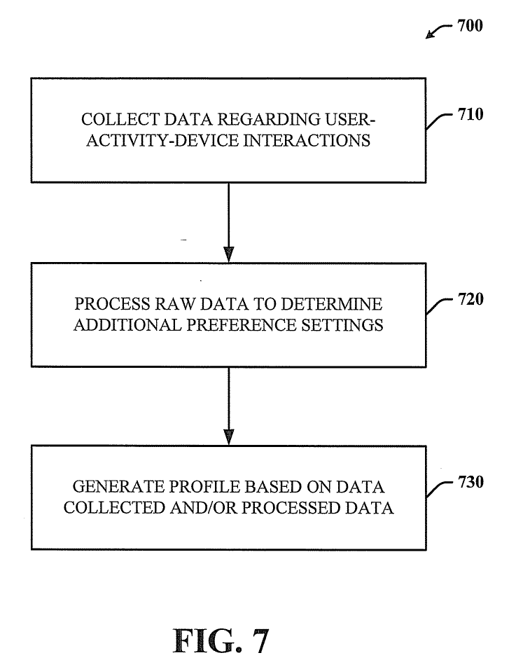

Referring now to FIG. 7, there is a flow diagram of an exemplary method 700 that facilitates managing user activities in an activity-centric computing environment via the creation of a master or universal profile. The method 700 involves collecting raw data regarding user-activity-device interactions at 710. The collection of such data can be performed passively without direct user input. Alternatively, the method can survey the user or explicitly request information from the user. At 720, the collected data (raw data) can be further processed to determine additional preference or policy settings. This processing can include employing inference techniques or adaptive learning mechanisms based on previous user input to obtain other settings for the user, group, or device profiles. It should be appreciated that activity template, group, and/or device profile data can be included within the master user profile and thus follow the user.

At 730, the profiles for the user, the user's devices, and activity templates used by the user can be generated within a master profile or in separate profiles. Group profile data can be maintained in the master user profile or can be stored elsewhere and accessed as needed according to the groups listed in the user's profile.

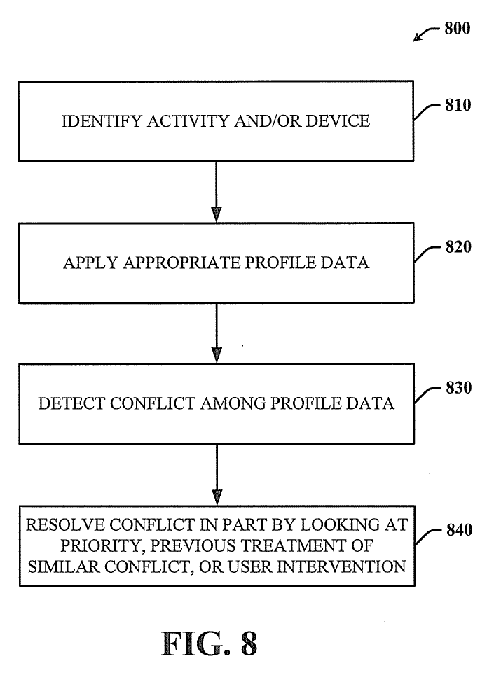

Referring now to FIG. 8, there is a flow diagram of an exemplary method 800 that makes selective use of one or more profiles in order to facilitate an activity-centric computing environment for any one user. The method 800 involves identifying the user's activity and/or device on which the activity is employed at 810. At 820, the relevant profile data can be applied. When the profile data does not directly apply to the user's activity or device, the method 800 can determine which profile data appears to be most relevant to the activity or device and then apply that data accordingly. For example, if a user is engaged in a new activity, the method can find a preference setting for an established or known activity similar to the new activity and then apply the setting to the new activity. As a result, the user is not burdened with creating new profiles for each new activity or each new device.

In some cases, conflicts between profile data can occur particularly when multiple users, groups, or devices are involved in an activity. The method 800 can detect that a conflict exists at 830 and then can attempt to resolve the conflict at 840 by examining priority information among the users, groups, or devices. That is, the method can look at the hierarchal positions of the users, groups, or devices as appropriate. Alternatively or in addition, the method 800 can request the respective users or groups to resolve the conflict. When user or group intervention is required to resolve the conflict, the method 800 can learn from the user/group response and apply it accordingly when future conflicts arise.

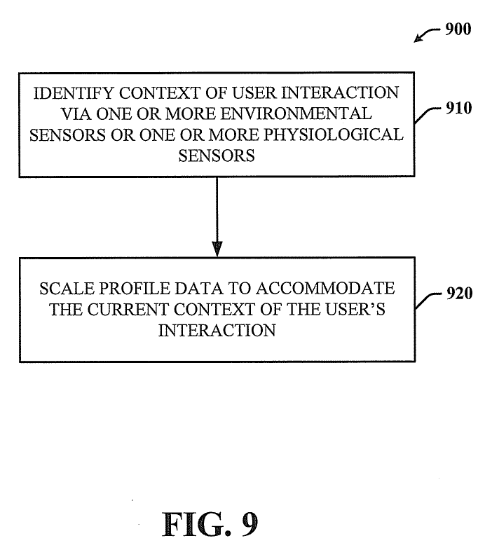

In addition to the type of activity, device, or group, the application of profile data can depend on the present context. FIG. 9 illustrates a flow diagram of an exemplary method 900 that facilitates scaling of profile data according to the current context. The method 900 involves identifying the context of the user's interaction with an activity and/or device via one or more environmental sensors or one or more physiological sensors at 910. At 920, the profile data can be scaled to accommodate the current context of the user's interaction.

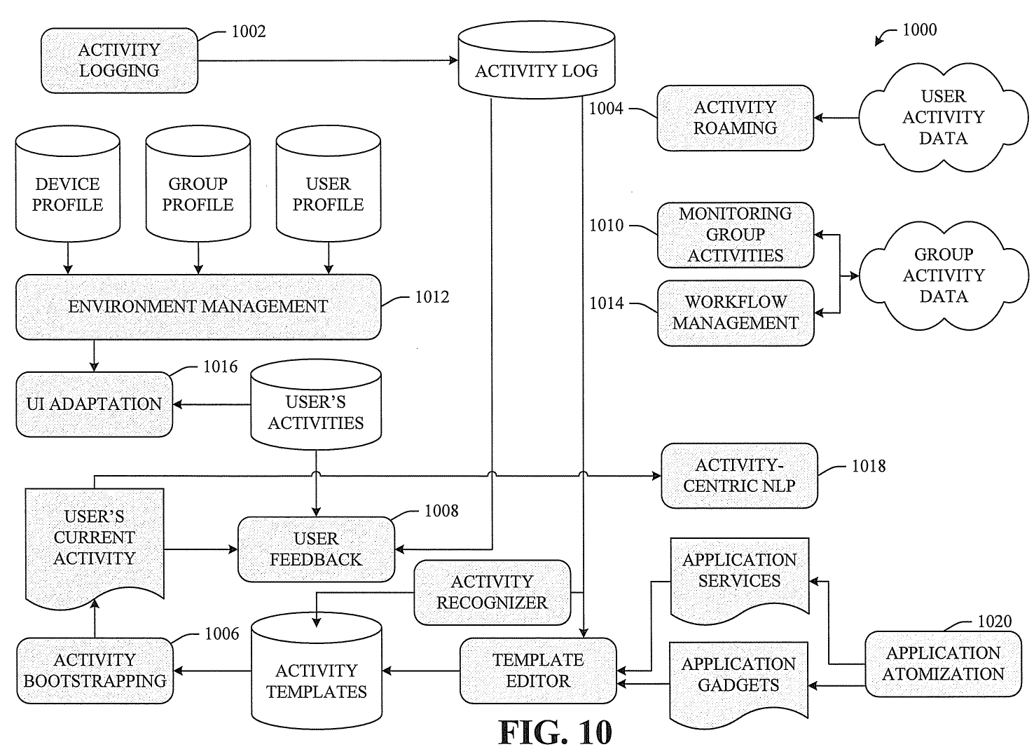

Turning now to FIG. 10, an overall activity-centric system 1000 operable to perform the various functionalities described herein is shown. As well, it is to be understood that the activity-centric system of FIG. 10 is illustrative of an exemplary system capable of performing the novel functionality of the Related Applications identified supra and incorporated by reference herein. Specific aspects of each of the components of system 1000 are described below.

The activity-centric system 1000 can enable users to define and organize their work, operations, and/or actions into units called “activities.” Accordingly, the system 1000 offers a user experience centered on those activities, rather than pivoted based upon the applications and files of traditional systems. The activity-centric system 1000 can also usually include a logging capability, which logs the user's actions for later use.

In accordance with the innovation, an activity typically includes or links to all the resources needed to perform the activity, including tasks, files, applications, web pages, people, email, and appointments. Some of the benefits of the activity-centric system 1000 include easier navigation and management of resources within an activity, easier switching between activities, procedure knowledge capture and reuse, improved management of activities and people, and improved coordination among team members and between teams.

As described herein and illustrated in FIG. 10, the system 1000 discloses an extended activity-centric system. However, the particular innovation (e.g., profile management) disclosed herein is part of the larger, extended activity-centric system 1000. An overview of this extended system 1000 follows.

The “activity logging” component 1002 can log the user's actions on a device to a local (or remote) data store. By way of example, these actions can include, but are not limited to include, resources opened, files changed, application actions, etc. As well, the activity logging component 1002 can also log current activity and other related information. This data can be transferred to a server that holds the user's aggregated log information from all devices used. The logged data can later be used by the activity system in a variety of ways.

The “activity roaming” component 1004 is responsible for storing each of the user's activities, including related resources and the “state” of open applications, on a server and making them available to the device(s) that the user is currently using. As well, the resources can be made available for use on devices that the user will use in the future or has used in the past. The activity roaming component 1004 can accept activity data updates from devices and synchronize and/or integrate them with the server data.

The “activity boot-strapping” component 1006 can define the schema of an activity. In other words, the activity boot-strapping component 1006 can define the types of items it can contain. As well, the component 1006 can define how activity templates can be manually designed and authored. Further, the component 1006 can support the automatic generation, and tuning of templates and allow users to start new activities using templates. Moreover, the component 1006 is also responsible for template subscriptions, where changes to a template are replicated among all activities using that template.

The “user feedback” component 1008 can use information from the activity log to provide the user with feedback on his activity progress. The feedback can be based upon comparing the user's current progress to a variety of sources, including previous performances of this or similar activities (using past activity log data) as well as to “standard” performance data published within related activity templates.

The “monitoring group activities” component 1010 can use the log data and user profiles from one or more groups of users for a variety of benefits, including, but not limited to, finding experts in specific knowledge areas or activities, finding users that are having problems completing their activities, identifying activity dependencies and associated problems, and enhanced coordination of work among users through increased peer activity awareness.

The “environment management” component 1012 can be responsible for knowing where the user is, the devices that are physically close to the user (and their capabilities), and helping the user select the devices used for the current activity. The component 1012 is also responsible for knowing which remote devices might be appropriate to use with the current activity (e.g., for processing needs or printing).

The “workflow management” component 1014 can be responsible for management and transfer of work items that involve other users or asynchronous services. The assignment/transfer of work items can be ad-hoc, for example, when a user decides to mail a document to another user for review. Alternatively, the assignment/transfer of work items can be structured, for example, where the transfer of work is governed by a set of pre-authored rules. In addition, the workflow manager 1014 can maintain an “activity state” for workflow-capable activities. This state can describe the status of each item in the activity, for example, which it is assigned to, where the latest version of the item is, etc.

The “UI adaptation” component 1016 can support changing the “shape” of the user's desktop and applications according to the current activity, the available devices, and the user's skills, knowledge, preferences, policies, and various other factors. The contents and appearance of the user's desktop, for example, the applications, resources, windows, and gadgets that are shown, can be controlled by associated information within the current activity. Additionally, applications can query the current activity, the current “step” within the activity, and other user and environment factors, to change their shape and expose or hide specific controls, editors, menus, and other interface elements that comprise the application's user experience.

The “activity-centric recognition” component or “activity-centric natural language processing (NLP) component 1018 can expose information about the current activity, as well as user profile and environment information in order to supply context in a standardized format that can help improve the recognition performance of various technologies, including speech recognition, natural language recognition, desktop search, and web search.

Finally, the “application atomization” component 1020 represents tools and runtime to support the designing of new applications that consist of services and gadgets. This enables more fine-grained UI adaptation, in terms of template-defined desktops, and well as adapting applications. The services and gadgets designed by these tools can include optional rich behaviors, which allow them to be accessed by users on thin clients, but deliver richer experiences for users on devices with additional capabilities.

In accordance with the activity-centric environment 1000, once the computer understands the activity, it can adapt to that activity. For example, if the activity is the review of a multi-media presentation, the application can display the information differently as opposed to an activity of the UI employed in creating a multi-media presentation. All in all, the computer can react and tailor functionality and the UI characteristics based upon a current state and/or activity. The system 1000 can understand how to bundle up the work based upon a particular activity. Additionally, the system 1000 can monitor actions and automatically bundle them up into an appropriate activity or group of activities. The computer will also be able to associate a particular user to a particular activity, thereby further personalizing the user experience.

In summary, the activity-centric concept of the subject system 1000 is based upon the notion that users can leverage a computer to complete some real world activity. As described supra, historically, a user would outline and prioritize the steps or actions necessary to complete a particular activity mentally before starting to work on that activity on the computer. In other words, conventional systems do not provide for systems that enable the identification and decomposition of actions necessary to complete an activity.

The subject activity-centric systems enable automating knowledge capture and leveraging the knowledge with respect to previously completed activities. In other words, in one aspect, once an activity is completed, the subject innovation can infer and remember what steps were necessary when completing the activity. Thus, when a similar or related activity is commenced, the activity-centric system can leverage this knowledge by automating some or all of the steps necessary to complete the activity. Similarly, the system could identify the individuals related to an activity, steps necessary to complete an activity, documents necessary to complete, etc. Thus, a context can be established that can help to complete the activity next time it is necessary to complete. As well, the knowledge of the activity that has been captured can be shared with other users that require that knowledge to complete the same or a similar activity.

Historically, the computer has used the desktop metaphor, where there was effectively only one desktop. Moreover, conventional systems stored documents in a filing cabinet where, there was only one filing cabinet. As the complexity of activities rises, and as the similarity of the activities diverges, it can be useful to have many desktops available that can utilize identification of these similarities in order to streamline activities. Each individual desktop can be designed to achieve a particular activity. It is a novel feature of the innovation to build this activity-centric infrastructure into the operating system such that every activity developer and user can benefit from the overall infrastructure.

The activity-centric system proposed herein is made up of a number of components as illustrated in FIG. 10. It is the combination and interaction of these components that compromises an activity-centric computing environment and facilitates the specific novel functionality described herein. At the lowest level the following components make up the core infrastructure that is needed to support the activity-centric computing environment: Logging application/user actions within the context of activities, User profiles and activity-centric environments, Activity-centric adaptive user interfaces, Resource availability for user activities across multiple devices, and Granular applications/web-services functionality factoring around user activities. Leveraging these core capabilities with a number of higher-level functions are possible, including: providing user information to introspection, creating and managing workflow around user activities, capturing ad-hoc and authored process and technique knowledge for user activities, improving natural language and speech processing by activity scoping, and monitoring group activity.

What has been described above includes examples of the subject system and/or method. It is, of course, not possible to describe every conceivable combination of components or methodologies for purposes of describing the subject system and/or method, but one of ordinary skill in the art may recognize that many further combinations and permutations of the subject system and/or method are possible. Accordingly, the subject system and/or method are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A profile management system that facilitates managing user activity in an activity-centric computing environment comprising:
an activity monitoring module that monitors activity conducted on one or more computing devices and collects data associated with such activity and the one or more devices; and
a profile generation component that generates profile data based at least in part upon the data collected whereby the profile data follows and stays with its user-owner and is applicable and extendible across devices, applications, and activity templates.

2. The system of claim 1, wherein the profile generation component processes the data to yield or infer additional profile data.

3. The system of claim 1 further comprises a privacy component that protects sensitive profile data from unauthorized or general viewing.

4. The system of claim 1 further comprises a prioritization component that assigns priority levels to at least a portion of the profile data to mitigate or resolve conflicts between competing profile data.

5. The system of claim 1, wherein the profile data comprises at least one of the following: user profile data, device profile data, activity template profile data, and group profile data.

6. The system of claim 1 wherein the profile generation component generates group profile data in part by including profile data that is common among the profile data belonging to the individual group members and in part by analyzing at least one of a group's purpose, focus, or intent to facilitate determining relevant profile data.

7. A profile management system that makes selective use of profile data in order to facilitate an activity-centric computing environment comprising:
an activity identification component that identifies a current activity desiring to access the profile data;
an activity analysis component that determines whether the activity is at least one of user, group, and device oriented; and
a profile data selection component retrieves the most relevant profile data and automatically implements it.

8. The system of claim 7 further comprises a conflict analysis component that analyzes conflicts between the relevant profile data and resolves them in part by applying the profile data according to at least one of the following: priority of the profile data or a purpose, focus, or intent of the current activity.

9. The system of claim 7 further comprises a machine learning component that learns user-created resolutions to conflicts previously encountered between users, devices, groups, and/or activity templates and applies learned resolutions to subsequent conflicts.

10. The system of claim 7 further comprises a profile data controller component that controls the exposure of profile data and selectively exposes the profile data that is pertinent to the current activity, device, and/or group.

11. The system of claim 7 further comprises a profile scaling component that scales at least a portion of the profile data based in part on a context of the current activity, device, user, and/or group.

12. The system of claim 11 further comprises at least one of the following: one or more environmental sensors and one or more physiological sensors, wherein the context of the current activity, device, user, and/or group is determined in part by the one or more sensors.

13. A method that facilitates managing user activity in an activity-centric computing environment comprising:
collecting data regarding user-activity-device interactions;
processing at least a portion of the data collected to determine additional preference or policy settings; and
generating a master profile comprising multiple types of profile data based on a user, the user's devices, and activity templates used by the user, whereby the master profile follows the user across devices and activity templates and is extendible to at least one of new devices and new activity templates.

14. The method of claim 13, wherein collecting the data is performed in at least one of the following ways: passively without direct user input or explicitly by surveying or requesting information from the user.

15. The method of claim 13, wherein processing at least a portion of the data collected comprises employing one or more inference techniques or adaptive learning mechanisms to learn from at least one of the following: previous user input or existing profile data.

16. The method of claim 13 further comprises making use of the master profile which comprises:
identifying at least one of an activity, activity template, user, device(s), or group that desires access to the profile data;
retrieving at least a portion of applicable profile data from the master profile;
detecting that a conflict exists between the applicable profile data; and
resolving the conflict by performing at least one of the following: applying the profile data in order of priority or requesting user intervention.

17. The method of claim 16, wherein resolving the conflict comprises learning from prior user intervention and adapting such resolution to a current conflict.

18. The method of claim 16 further comprises scaling profile data based on a context of at least one of the activity, activity template, user, device(s), or group.

19. The method of claim 18, wherein the context is determined in part by detecting at least one of environmental and physiological conditions.

20. The method of claim 16 further comprises applying existing profile data to at least one of a new activity, activity template, user, device, or group so that new profile data does not have to be explicitly created by the user.
